(19) United States
(12) Patent Application Publication
(10) Pub. No.: US 2024/0420859 A1
(43) Pub. Date: Dec. 19, 2024

(54) Mixed Particle Nuclear Reactions

(71) Applicant: Roger X. Lenard, Edgewood, NM (US)

(72) Inventor: Roger X. Lenard, Edgewood, NM (US)

(21) Appl. No.: 18/211,254

(22) Filed: Jun. 17, 2023

(51) Int. Cl. G21D 5/02; G21C 3/328; G21C 5/14; G21C 7/04

(52) U.S. Cl. CPC G21D 5/02; G21C 3/328; G21C 5/14; G21C 7/04; B64G 1/408

(57) ABSTRACT

Methods, systems, and devices for producing hot fluid from a reactor are disclosed. A mix of moderator particles, fuel particles, and reflector particles are configured to produce heat by nuclear reactions.

### TECHNICAL FIELD

This disclosure relates generally to mixed particle nuclear reactions.

### BACKGROUND

Nuclear reactions, both for electrical power production, and for nuclear propulsion, suffer from limitations due to size considerations and thermal distribution issues.

### SUMMARY

In a first aspect, the disclosure provides a system for producing hot fluid. An annular reactor column containing a mix of moderator particles, fuel particles, and reflector particles is configured to produce heat by nuclear reactions. A cold frit is configured to pass coolant fluid through a first surface of the annular reactor column and through the annular reactor column. A hot frit on a second surface of the annular reactor column is configured to receive hot fluid from the annular reactor column into a discharge space adjacent the hot frit.

In a second aspect, the disclosure provides a device for producing hot fluid. An annular reactor column contains moderator particles, fuel particles, and reflector particles mixed together to produce heat by nuclear reactions. A cold frit is on a first surface of the annular reactor column. A hot frit is on a second surface of the annular reactor and adjacent a discharge space. A coolant fluid is passed through the cold frit through the annular reactor column and through the hot frit into the discharge space as the hot fluid.

In a third aspect, the disclosure provides a method for producing hot fluid. An annular reactor column bounded by a cold frit on a first surface and a hot frit on a second surface is provided with a mix of moderator particles, fuel particles, and reflector particles. A coolant fluid is passed through the cold frit into the annular reactor column such that nuclear reactions in the fuel particles heat the coolant fluid into a hot fluid. The hot fluid is passed through the hot frit and into a discharge space.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1A is a cross-sectional view of a nuclear rocket containing annular reactor columns.

FIG. 1B is a cross-sectional isometric view of an annular reactor column of FIG. 1A.

FIG. 2 is a cross-sectional view of a moderator particle.

FIG. 3 is a cross-sectional view of a fuel particle.

FIG. 4 is a cross-sectional view of a reflector particle.

FIG. 5 is a cross-sectional view of a poison particle.

FIG. 6 is a block diagram showing a method for producing hot fluid and propulsion.

FIG. 7 is a block diagram showing a method for producing hot fluid and electricity.

FIG. 8A is a cross-sectional top view of an annular reactor column.

FIG. 8B is a cross-sectional side view of a portion of the annular reactor column of FIG. 8A.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

In the past, most space nuclear power and propulsion system reactors employed Highly Enriched Uranium (HEU). More recently, the Defense Threat Reduction Act (DTRA), has sought to replace utilization of HEU with High Assay Low Enriched Uranium (HALEU), which is an enrichment value of <20% enriched 235U. Most reactor concepts employing HEU employ fast or fission spectrum neutrons. The 235U fast neutron absorption spectrum is ˜500× smaller than the fission absorption spectrum for thermal neutrons. Historically, thermal spectrum reactors place the moderator (a device which slows down (thermalizes) neutrons), on the outside of a fuel element, with (in the case of a particle-bed reactor (PBR)) fuel particles on the inside of a fuel element and a moderator block, (typically containing hydrogen atoms), on the outside of the fuel element. Because the fission neutron absorption spectrum for thermal neutrons is ˜500× that for fast neutrons, any thermal neutrons generated by the external moderator block will be quickly absorbed in the first several millimeters of the fuel element. Consequently, the fuel element experiences a significant decaying radial power profile. Additionally, since space reactors need to be small, lightweight and compact, the presence of an external moderator cannot help but increase the size of the reactor, hence its size and weight as well as increasing the size and weight of the radiation shield. Further, with an external moderator in a thermal spectrum reactor, the reactor is typically under-moderated. If the reactor is immersed in water, (e.g., a launch vehicle accident), it experiences a substantial surge in reactivity, which could lead to inadvertent criticality, a situation which can result in a more difficult launch safety analysis.

One embodiment of this invention involves three new particles which complement the fuel particles of the PBR. The fuel particle in a space PBR is a modified TRISO particle. For nuclear thermal rocket engines, the particle contains a fuel kernel typically made from a uranium ceramic (UC2, UN), which is encased in a porous graphite coat, (to retain fission products), a coating of pyrolytic graphite, followed by a coating of ZrC. A space power reactor may employ a different exterior coat of fuel kernel since the reactor operating temperature is much lower.

The three new particles serve different, but highly interdependent functions. The fuel particle is the particle subjected to the fission energy generation process. The moderator particle, which contains either ZrH2 or YH3 in its kernel is used to thermalize the fission neutrons occurring as a result of the fission process so they become a more efficient neutron source for fission within the particle bed. The reflector particles are used at the ends of the fuel element and generally contain Be2C. These particles form a neutron reflector to reflect neutrons back into the fuel element making the reactor more efficient, enabling it to be smaller. In higher temperature reactors, the Be2C particles can perform a moderating function as well. Finally, there is a burnable poison particle. Burnable poisons are used in some commercial reactor fuel to offset excess reactivity associated with a long-life reactor core. In some embodiments, the stoichiometric ratio of hydrogen to Zirconium or Yttrium can be integer values. In other embodiments, the ratio is a non-integer value. In any embodiment, this can still be described as ZrH2 or YH3. In some embodiments, as the reactor operates, the poison particles absorb neutrons and are transmuted into an atom that does not absorb neutrons. Simultaneously, as nuclear fuel is burned, the amount of uranium decreases. As such, the reduced negative worth of the poison particles is offset by the reduced positive worth of the burned nuclear fuel.

In a Nuclear Thermal Propulsion (NTP) application, in addition to the task of reflecting neutrons back into the core, the reflector particles also form a transition zone to minimize thermal gradients at the ends of the fuel element.

Mixing the fuel and moderator particles in the fuel element allow the reactor to be optimally moderated. In addition to this enabling the reactor to be the smallest and lightest possible combination, if this reactor is immersed in water, the result is an over-moderated core, which cannot become critical. This yields a designed-in safety factor, which will ease the launch approval process. A typical construction technique for an externally moderated PBR is a series of fuel elements, typically in a hexagonal close-packed (HCP) array, filled with large number of fuel particles which are combined between a cold frit and a hot frit, with an external moderator.

One difference between a fuel element which has a mixture of moderator particles and a fuel element employing an external moderator is size. The mixed fuel/moderator bed is substantially smaller in diameter than the externally moderated fuel element. Also, in removing the external moderator, the whole reactor can shrink in size. The mixed fuel/moderator particle bed eliminates the potential for highly on-uniform radial power profiles. By moderating the fuel element by sectors, azimuthal power profiles can also be eliminated. No longer is a specially orificed cold frit required. Due to neutron population densities, the normal axial power profiles will be exhibited, however, these will be quite uniform once the other uneven power profiles are managed.

The introduction of a burnable poison particle enables a fully engineered PBR fuel element for very long reactor operational lifetime. Burnable poisons are routinely used in commercial reactors to enable longer lifetimes without having to generate excessively large control swings. While a reactor can be designed with substantial excess reactivity, provide control and shutdown worth in a small space reactor is very difficult, particularly in the case of when it might fall into water due to a launch vehicle accident.

Typical burnable poisons include such elements as ¹⁰B or Gadolinium. Boron-10 has a very linear neutron absorption cross-section with neutron energy as shown in FIG. 5. Moreover, isotope ¹⁰B has a high (n, alpha) reaction cross-section along the entire neutron energy spectrum. The cross-sections of most other elements become very small at high energies, as in the case of cadmium. The cross-section of ¹⁰B decreases monotonically with energy. For fast neutrons, its cross-section is ˜3,900 barns. Boron, as the neutron absorber, has another positive property. The reaction products (after a neutron absorption), helium and lithium, are stable isotopes. Therefore. there are minimal problems with decay heating of control rods or burnable absorbers used in the reactor core. In fuel elements where the burnable poison is mixed in with the fuel, the helium decay product can exert internal pressures on the cladding. TRISO particle fuel, however is designed to allow for fluideous fission product generation by having a low-density graphite layer within the particle to capture fluideous products.

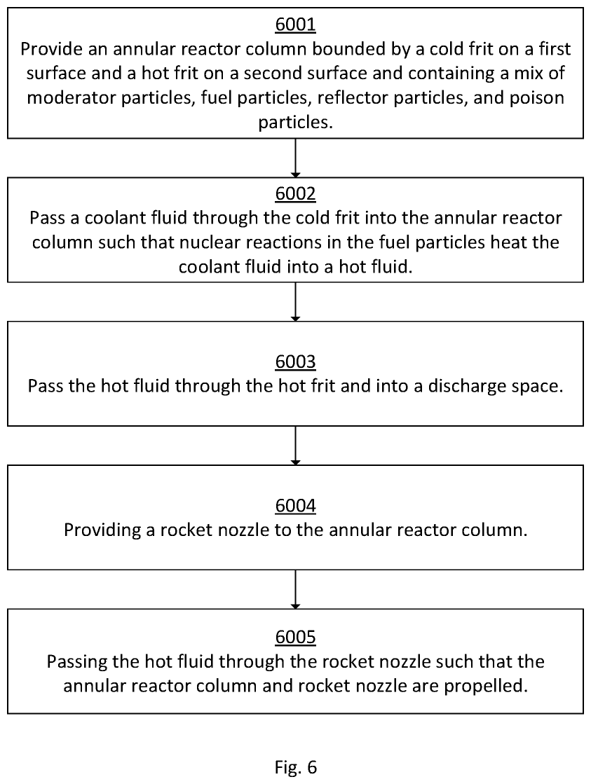

Another burnable poison is Gadolinium. Gadolinium is commonly used as a neutron absorber due to the very high neutron absorption cross-section of two isotopes 155Gd and 157Gd as shown in FIG. 6. Their absorption cross-sections are the highest among all stable isotopes. ¹⁵⁵Gd has 61,000 barns for thermal neutrons (for 0.025 eV neutron) and ¹⁵⁷Gd has 254,000 barns. For this reason, gadolinium is widely used as a burnable absorber, commonly used in fresh fuel to compensate for an excess of reactivity of reactor core. In comparison with other burnable absorbers, gadolinium behaves like a completely black material. Therefore, gadolinium is very effective in compensation of the excess of reactivity for a thermal spectrum reactor.

Given the relatively small size of the particle bed reactor, the introduction of a burnable poison will have a large influence on the potential reactor lifetime because more uranium can be introduced into the reactor core without requiring a larger control system to offset the additional reactivity. The larger the control worth the larger the reactor will be; hence, the introduction of burnable poisons can reduce the size of a reactor a given operating lifetime.

These developments will result in a completely optimized reactor. Recent developments in high-power computing allows the analysis of a very complex reactor with a high degree of precision in a short period of time. MCNP and SCALE-KENO are the gold-standard for neutronics codes; they have been upgraded to enable parallel processing further enabling a very rapid and low-cost reactor design process. The optimized reactor approach also simplifies the manufacturing process since the reactor power profile is so uniform.

The poison particles are used to allow a reactor with high reactivity to be operated within the range of lightweight and compact control surfaces. As the uranium fuel is consumed, the poison material in the poison particles is similarly consumed reducing their negative reactivity worth so the overall reactor reactivity operated within a range compatible with the reactor control system.

The resultant reactor is the smallest possible non-Highly Enriched Uranium reactor. It allows a very small reactor with engineered power distributions for the most uniform power production.

The first layer from the kernel is low density graphite, next is high density graphite, the outer layer is the particle coating silicon carbide or zirconium carbide

Low density graphite is used to trap fission products (solids and fluids).

High density graphite is a sealing layer to prevent the escape of fission products.

In one embodiment, the fuel particles, moderator particles, reflector particles, and poison particles are distributed such that the nuclear reactions produce a uniform radial and azimuthal heat distribution to uniformly heat the working fluid.

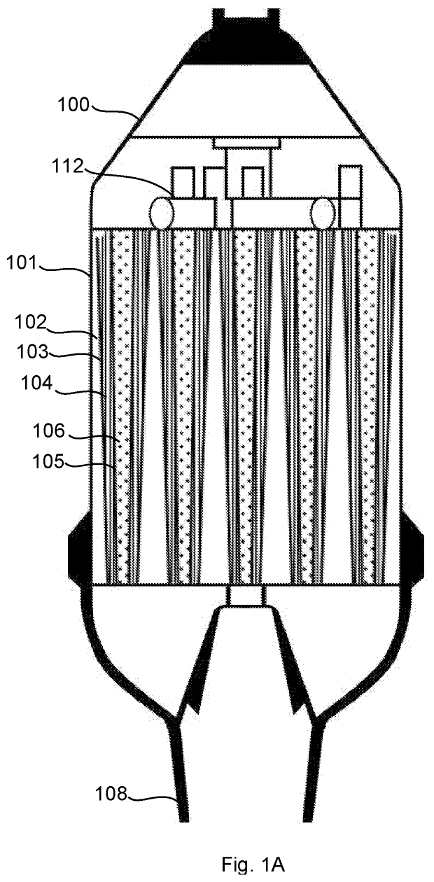

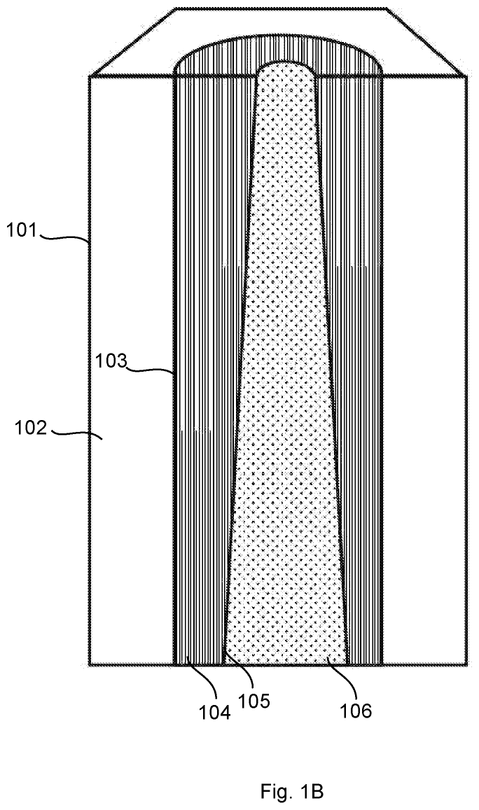

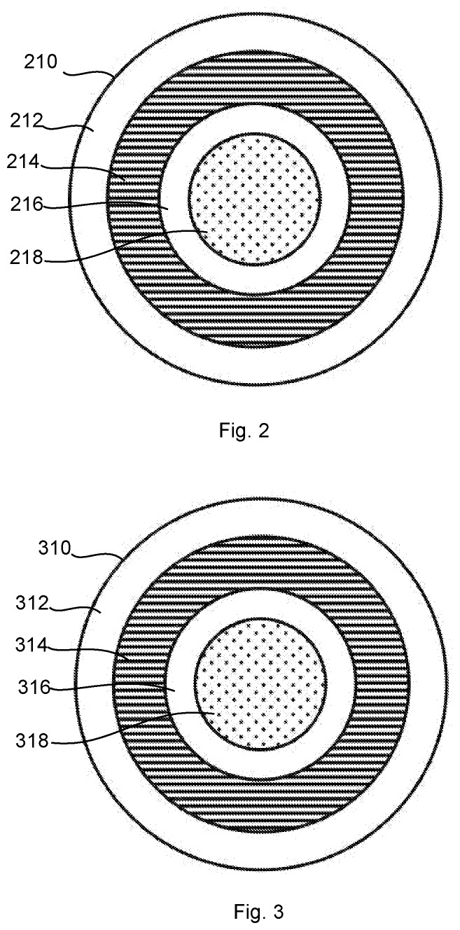

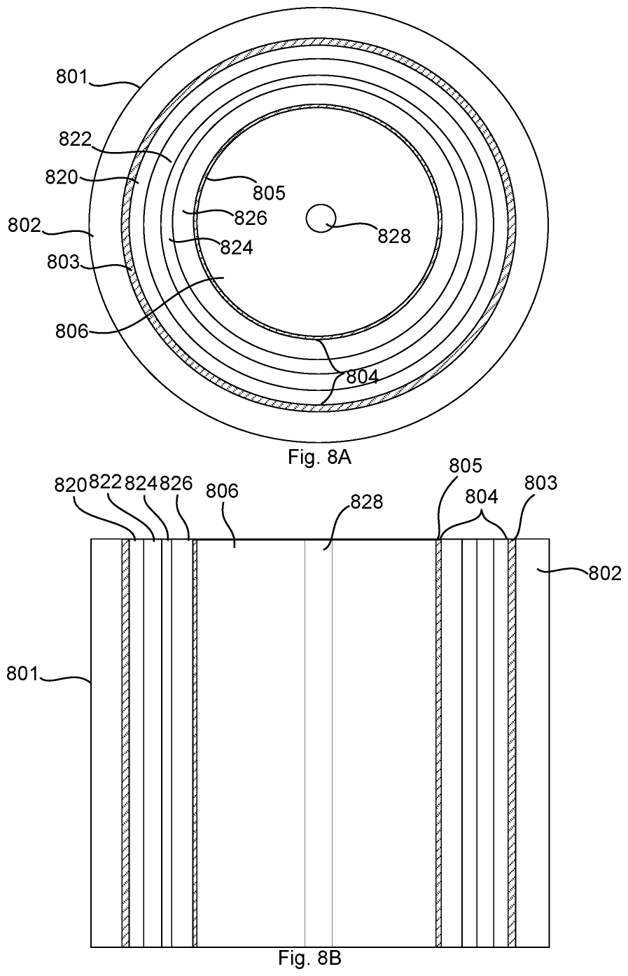

FIG. 1A is a cross-sectional view of a nuclear rocket containing annular reactor columns that may be used in one embodiment of the present invention. FIG. 1B is a cross-sectional isometric view of an annular reactor column of FIG. 1A. This embodiment is exemplary and not limiting the invention to rocketry. This embodiment is of special consideration for rocketry as the annular reactor columns described herein are lighter and more efficient than previous reactors intended for such rockets. The rocket 100 contains payload and fuel section 112, annular reactor columns 101, and rocket nozzle 108. The annular reactor columns 101 consist of a cold frit 103 and a hot frit 105 that bound a reactor area 104. Outside of the cold frit 103 is a fluid inlet space 102. Inside of the hot frit is a hot gas discharge space 106. Inside of the reactor area 104 are a variety of particles. These particles are shown in FIGS. 2, 3, 4, and 5, and include moderator particles 210, fuel particles 310, reflector particles 410, and, in some embodiments, poison particles 510. A combination of these particles distributed in a variety of patterns allows the annular reactor column 101 to heat the cold fluid to a hot gas and discharge it into the discharge space 106. The manner of this distribution is discussed in FIG. 8. The cold fluid is passed from the fluid inlet space 102, through the cold frit 103, and through the reactor area 104 where the cold fluid is heated up to a hot gas. The hot gas passes through the hot frit 105 and into the hot gas discharge space 106. The hot gas then continues on and exits the rocket 100 through the rocket nozzle 108. The hot gas accelerates the rocket 100 by transfer of momentum. The relative sizes of the rings of material in this embodiment was shown for convenience of drawing the figure and not for actual relative sizes. The rings in this and other embodiments can and would be of appropriate thicknesses to balance heat loads. Further, more rings of repeating particles can be used as appropriate for each unique application.

FIG. 2 is a cross-sectional view of a moderator particle that may be used in one embodiment of the present invention. The moderator particle 210 consists of an outer shell 212, a first inner shell 214, a second inner shell 216, and a core 218. In this embodiment, the outer shell 212 consists of ZrC or SiC, the first inner shell 214 consists of pyrolytic graphite, the second inner shell 216 consists of a porous graphite coat, and the core 218 consists of ZrH₂-x or YH3. In other embodiments, the shells have different materials, as is known to one of normal skill in the art, including TRISO-like particle coatings.

FIG. 3 is a cross-sectional view of a fuel particle that may be used in one embodiment of the present invention. The fuel particle 310 consists of an outer shell 312, a first inner shell 314, a second inner shell 316, and a core 318. In this embodiment, the outer shell 312 consists of ZrC or SiC, the first inner shell 314 consists of pyrolytic graphite, the second inner shell 316 consists of a porous graphite coat, and the core 318 consists of UC₂, UO₂, UCO, or UN. In other embodiments, the shells have different materials, as is known to one of normal skill in the art, including TRISO-like particle coatings.

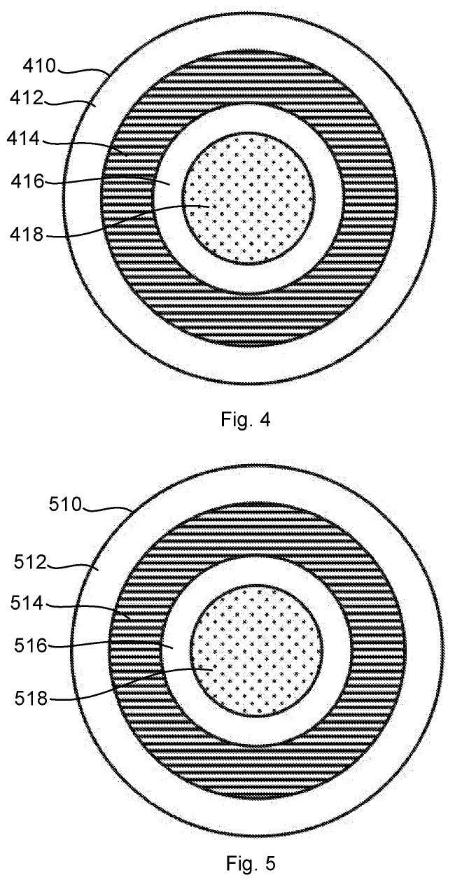

FIG. 4 is a cross-sectional view of a reflector particle that may be used in one embodiment of the present invention. The reflector particle 310 consists of an outer shell 312, a first inner shell 314, a second inner shell 316, and a core 318. In this embodiment, the outer shell 312 consists of ZrC or SiC, the first inner shell 314 consists of pyrolytic graphite, the second inner shell 316 consists of a porous graphite coat, and the core 318 consists of Be₂C or BeO. In other embodiments, the shells have different materials, as is known to one of normal skill in the art, including TRISO-like particle coatings.

FIG. 5 is a cross-sectional view of a poison particle that may be used in one embodiment of the present invention. The poison particle 410 consists of an outer shell 412, a first inner shell 414, a second inner shell 416, and a core 418. In this embodiment, the outer shell 412 consists of ZrC or SiC, the first inner shell 414 consists of pyrolytic graphite, the second inner shell 416 consists of a porous graphite coat, and the core 418 consists of ¹⁰B or Gd. In other embodiments, the shells have different materials, as is known to one of normal skill in the art, including TRISO-like particle coatings.

FIG. 6 is a block diagram showing a method for producing hot fluid and propulsion that may be used in one embodiment of the present invention. At 6001, an annular reactor column is provided. The annular reactor column is bounded by a cold frit on a first surface and a hot frit on a second surface. The space between the frits contains a mix of moderator particles, fuel particles, reflector particles, and in some embodiments, poison particles. At 6002, a coolant fluid is passed through the cold frit into the annular reactor column such that nuclear reactions in the fuel particles heat the coolant fluid into a hot fluid. At 6003, the hot fluid is passed through the hot frit and into a discharge space. At 6004, a rocket nozzle is provided adjacent the annular reactor column. At 6005, the hot fluid is passed through the rocket nozzle such that the annular reactor column and rocket nozzle are propelled by the transfer of momentum of the working fluid being expelled from the rocket nozzle. In one embodiment, the fluid is a liquid while cool and expands into a gas as the hot fluid. In other embodiments, the fluid is a gas both as coolant and as the hot fluid. In some embodiments, the fluid is hydrogen, oxygen, nitrogen, water, carbon dioxide, or a noble gas.

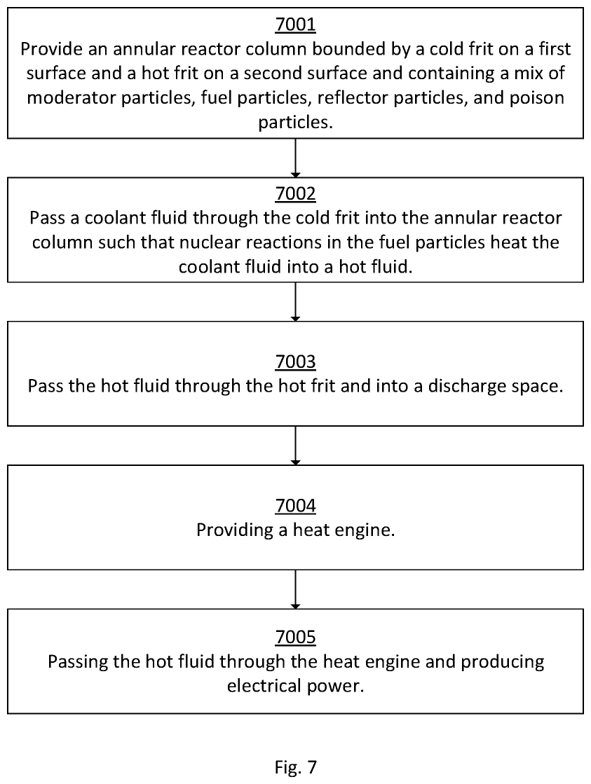

FIG. 7 is a block diagram showing a method for producing hot fluid and electricity that may be used in one embodiment of the present invention. At 7001, an annular reactor column is provided. The annular reactor column is bounded by a cold frit on a first surface and a hot frit on a second surface. The space between the frits contains a mix of moderator particles, fuel particles, reflector particles, and in some embodiments, poison particles. At 7002, a coolant fluid is passed through the cold frit into the annular reactor column such that nuclear reactions in the fuel particles heat the coolant fluid into a hot fluid. At 7003, the hot fluid is passed through the hot frit and into a discharge space. At 7004, a heat engine is provided. At 7005, the hot fluid is passed through the heat engine to produce electrical power. In one embodiment, the fluid is a liquid while cool and expands into a gas as the hot fluid. In some embodiments, the fluid is water as a liquid and steam as the hot fluid. In some embodiments, the heat engine utilizes a Brayton cycle or variants.

FIG. 8A is a cross-sectional top view of an annular reactor column that may be used in one embodiment of the present invention. FIG. 8B is a cross-sectional side view of a portion of the annular reactor column of FIG. 8A. The distribution of particles is exemplary and other distributions are possible to tune the nuclear reaction to produce the heating profile desired. In this embodiment, the annular reactor column 801 consists of a cold frit 803 and a hot frit 805. The cold frit 803 is surrounded by a fluid inlet space 802. The hot frit 805 surrounds a hot fluid discharge space 806. The reactor space 804 is between the hot frit 805 and the cold frit 803. Inside the reactor space 804 are layers of particles 820, 822, 824, and 826. This is exemplary only, and other numbers of layers are realizable. In one embodiment, these layers consist of moderator particles 210, fuel particles 310, moderator particles 210, and reflector particles 410, respectively. Poison particles 510 may be included at beginning of reactor life in column 828 in the center of the discharge space or may be added after startup at a rate needed to keep the heat at the desired profile. When poison particles are included at startup, they can also be distributed as needed through any of the layers. The relative sizes of the rings of material in this embodiment was shown for convenience of drawing the figure and not for actual relative sizes. The rings in this and other embodiments can and would be of appropriate thicknesses to balance heat loads. Further, more rings of repeating particles can be used as appropriate for each unique application.

In some embodiments, more layers alternating moderator/fuel would be added. In some embodiments, the reflector particles would make up the outermost layer. In other embodiments, other particles would make up the outermost layer.

In one embodiment, each layer consists of moderator and fuel particles interspersed at random and the outermost layer consists of reflector particles.

In other embodiments, the cold and hot frits are swapped and the discharge space is the external space of the reactor column and the inlet is the inner space of the reactor column.

In some embodiments, the poison particles are provided in a quantity such that consumption of nuclear fuel in the fuel particles is balanced by the consumption of the poison particles to maintain steady overall hot fluid production.

In some embodiments, the annular reactor column begins with the cross section of the reactor area 104 larger and the area tapers towards the bottom, as in FIG. 1A and B. In other embodiments, the reactor area remains constant, but the distribution of the particles 210, 310, 410, and 510 varies from the top of the reactor to the bottom of the reactor. In some embodiments, the area tapers and the particle distribution varies.

The invention has been described with reference to various specific and preferred embodiments and techniques. Nevertheless, it is understood that many variations and modifications may be made while remaining within the spirit and scope of the invention.

What is claimed is:

1. A system for producing hot fluid comprising:
an annular reactor column containing a mix of moderator particles, fuel particles, and reflector particles and configured to produce heat by nuclear reactions;
a cold frit configured to pass coolant fluid through a first surface of the annular reactor column and through the annular reactor column;
a hot frit on a second surface of the annular reactor column configured to receive hot fluid from the annular reactor column into a discharge space adjacent the hot frit.

2. The invention of claim 1, wherein the moderator particles, fuel particles, and reflector particles are distributed through the annular reactor column in radial mono-layers, alternating between moderator particles, fuel particles, reflector particles, and poison particles.

3. The invention of claim 1, wherein the moderator particles, fuel particles, and reflector particles are distributed through the annular reactor column such that heat is produced in a flat profile.

4. The invention of claim 1, wherein the fuel particles, moderator particles, and reflector particles are distributed such that the nuclear reactions produce a uniform radial and azimuthal heat distribution.

5. The invention of claim 1, further comprising poison particles provided in a quantity such that consumption of nuclear fuel in the fuel particles is balanced by the consumption of the poison particles and overall hot fluid production remains steady.

6. The invention of claim 1, wherein the annular reactor column is mounted to a rocket nozzle configured to propel the annular reactor column by expulsion of the hot fluid.

7. The invention of claim 1, wherein a heat engine is configured to convert the hot fluid to electrical power.

8. The invention of claim 1, wherein poison particles are added to the annular reactor column as nuclear fuel in the fuel particles is consumed in a center of the annular reactor column.

9. A device for producing hot fluid comprising:
an annular reactor column comprising moderator particles, fuel particles, and reflector particles mixed together to produce heat by nuclear reactions;
a cold frit on a first surface of the annular reactor column;
a hot frit on a second surface of the annular reactor and adjacent a discharge space; and
wherein a coolant fluid is passed through the cold frit through the annular reactor column and through the hot frit into the discharge space as the hot fluid.

10. The invention of claim 9, wherein the moderator particles, fuel particles, and reflector particles are distributed through the annular reactor column in radial mono-layers, alternating between moderator particles, fuel particles, reflector particles, and poison particles.

11. The invention of claim 9, wherein the moderator particles, fuel particles, and reflector particles are distributed through the annular reactor column such that heat is produced in a flat profile.

12. The invention of claim 9, wherein the fuel particles, moderator particles, and reflector particles are distributed such that the nuclear reactions produce a uniform radial and azimuthal heat distribution.

13. The invention of claim 9, further comprising poison particles provided in a quantity such that consumption of nuclear fuel in the fuel particles is balanced by the consumption of the poison particles and overall hot fluid production remains steady.

14. The invention of claim 9, wherein the annular reactor column is mounted to a rocket nozzle which is configured to propel the annular reactor column by expulsion of the hot fluid.

15. The invention of claim 9, further comprising a heat engine configured to receive the hot fluid and produce electrical power.

16. A method for producing hot fluid comprising:
providing an annular reactor column bounded by a cold frit on a first surface and a hot frit on a second surface and containing a mix of moderator particles, fuel particles, and reflector particles;
passing a coolant fluid through the cold frit into the annular reactor column such that nuclear reactions in the fuel particles heat the coolant fluid into a hot fluid;
passing the hot fluid through the hot frit and into a discharge space.

17. The invention of claim 16, wherein the moderator particles, fuel particles, reflector particles, and poison particles are provided in a distribution through the annular reactor column in radial mono-layers, alternating between moderator particles, fuel particles, and reflector particles, or in a distribution such that the nuclear reactions produce a uniform radial and azimuthal heat distribution.

18. The invention of claim 16, further comprising poison particles provided in a quantity such that consumption of nuclear fuel in the fuel particles is balanced by the consumption of the poison particles and overall hot fluid production remains steady.

19. The invention of claim 16, further comprising providing a rocket nozzle to the annular reactor column and passing the hot fluid through the rocket nozzle such that the annular reactor column and rocket nozzle are propelled.

20. The invention of claim 16, further comprising passing the hot fluid through a heat engine and producing electrical power.
